(19) United States
(12) Patent Application Publication
(10) Pub. No.: US 2004/0044931 A1
(43) Pub. Date: Mar. 4, 2004

(54) Method and device for determining an error rate of biometric devices

(76) Inventors: Manfred Bromba, Munchen (DE); Dietmar Gosseringer, A-Graz (AT); Kurt Heschgl, Graz (AT)

Correspondence Address: BELL, BOYD & LLOYD, LLC, P. O. BOX 1135, CHICAGO, IL, 60690-1135, US

(21) Appl. No.: 10/433,105

(22) PCT Filed: Nov. 27, 2001
(86) PCT No.: PCT/EP01/13848

(30) Foreign Application Priority Data
Nov. 29, 2000 (EP) 00126077.7

(51) Int. Cl. G06F 11/00

(52) U.S. Cl. 714/704

(57) ABSTRACT

In order to determine the error rate of a biometric device, a number of foreign characteristic sets are stored in a database, which are compared during a testing process with the characteristic set of the authorized person, and personal error rates are determined for the authorized person based on this comparison.

The invention relates to a method for determining an error rate for a biometric device which releases an access when a biometric characteristic of a person, input by means of at least one biometric sensor when prompted, matches a characteristic. of an authorized person stored as a characteristic set and rejects an access when said biometric characteristic does not match, whereby, in order to determine the error rate, a current biometric characteristic of an authorized person is tested against a number of foreign biometric characteristics and the error rates are defined by the frequency with which access is granted for an unauthorized person and the frequency with which access is rejected for an authorized person.

The invention also relates to a biometric device with at least one biometric sensor, said device being set to release an access when a biometric characteristic of a person, input by means of the sensor when prompted, matches a characteristic of an authorized person stored as a characteristic set and to reject access when said biometric characteristic does not match.

Access or entry control using biometric devices, usually without input of a password or use of a key, is acquiring increasing significance. The biometric device records with the aid of a biometric sensor certain biometric characteristics of a person seeking access, e.g. the person's fingerprints, facial contour, voice, weight, etc. Characteristic features are usually extracted from the information obtained for the application concerned by scanning, e.g. by means of a sensor tip or a camera, and compiled into a characteristic set which is then compared in the devices with the stored characteristic set of the person having authorized access. If these match to a certain, specifiable degree, access is granted, otherwise access is refused. It is also possible for multiple biometric characteristics, e.g. a fingerprint and a voice pattern, to be combined, in order to increase security.

Since the measurement of biometric characteristics is never unambiguous in the same way as e.g. a numeric key, there are possibilities for error which are significant to the level of security. In particular, the false acceptance rate, which defines the frequency with which an unauthorized person obtains access, and the false rejection rate, which indicates the frequency with which an authorized person is rejected, are known. It is self-evident that both error rates should be as low as possible, the false acceptance error rate in particular being of especial importance for security.

When purchasing or commissioning a biometric device of the type that is the subject matter of the invention, the user must clearly know the error rates and these error rates must be selected according to the security requirements concerned.

In order to determine the specified error rates, extensive field tests involving very many participants are currently needed, which field tests will produce as results average values for a large number of people. In these tests, one person in each case is deemed to be authorized and tested out against a fairly large number of other persons. The error rates obtained, namely a false acceptance rate and a false rejection rate, are then assigned to the delivered device or system.

Practice has shown, however, that both the false acceptance rate and the false rejection rate depend very much on the person concerned, i.e. the “authorized person”. Since very many biometric devices are also personal devices, the personal variables, in particular, are of interest to a user, which would, however, require that extensive and costly tests be carried out with the biometric characteristics of the user concerned.

An object of the invention is to create a method which enables personal error rates to be determined in a relatively simple and cost-effective manner.

This object is achieved according to the invention by means of a method of the type referred to in the introduction in that a testing process is carried out in the biometric device using a database which contains a number of foreign characteristic sets in order to compare these foreign characteristic sets with the characteristic set of a stored current characteristic of the authorized person and in that personal error rates are determined for the authorized person on this basis.

The invention offers the advantage that a database has to be set up only once and can then, stored on a data medium, be supplied with the biometric device. The user must then input his/her biometric characteristic, e.g. a fingerprint, and the device subsequently executes a testing process in which the error rates can be determined.

An advantageous variant of the invention provides that, with the aid of a device equivalent to the biometric device at least with regard to the scanning of biometric characteristics, biometric characteristics of various third parties are recorded and stored as foreign characteristic sets in the database. Thus, in this variant, “real” test persons are used to build up the database.

If biometric characteristics are extracted from the information obtained behind a biometric sensor and stored in this form in the database, sufficient data can be found using a fraction of the storage space that would be needed if the information recorded directly by the sensor were stored.

A development of the method according to the invention provides that foreign characteristic sets with statistically distributed virtual characteristics are generated for the database, said characteristics behaving in terms of their properties like the characteristics of real persons. In this way, the situation can be prevented whereby a supplier to the foreign database obtains false values, for example for the false acceptance rate, because his/her characteristic set is also in this database and recognition takes place as a result. A further advantage of such an “artificial” database lies in the fact that the characteristic sets, e.g. fingerprints, do not have to be stored but are generated when they are needed. They can be deleted again after storage so that no storage space is wasted. An advantageous embodiment provides that the current characteristic of the authorized user, stored as a characteristic set, is determined by averaging a multiple number of scans of the current biometric characteristic of the user. All the user has to do in order to generate this average value, is to provide the biometric device with the current characteristic, e.g. his/her fingerprint, several times.

It is also usefully provided that the database is encoded and is decoded only temporarily for the testing process. This prevents any misuse, particularly with data from third parties.

As mentioned previously, the error rate is preferably determined as a false acceptance rate and/or a false rejection rate.

In order for the set object to be achieved, use can also be made of a biometric device of the type referred to in the introduction which is designed for the purpose of carrying out, by accessing a database which contains a number of foreign characteristic sets, a testing process in order to compare these foreign characteristic sets with the characteristic set of a stored current characteristic of the authorized person and to determine on this basis a personal error rate for the authorized person.

The advantages attainable with this device and those advantages which can be assigned to the dependent claims 9 to 13 have already been mentioned further above.

The invention together with further advantages is described in detail below with reference to the accompanying drawings, in which:

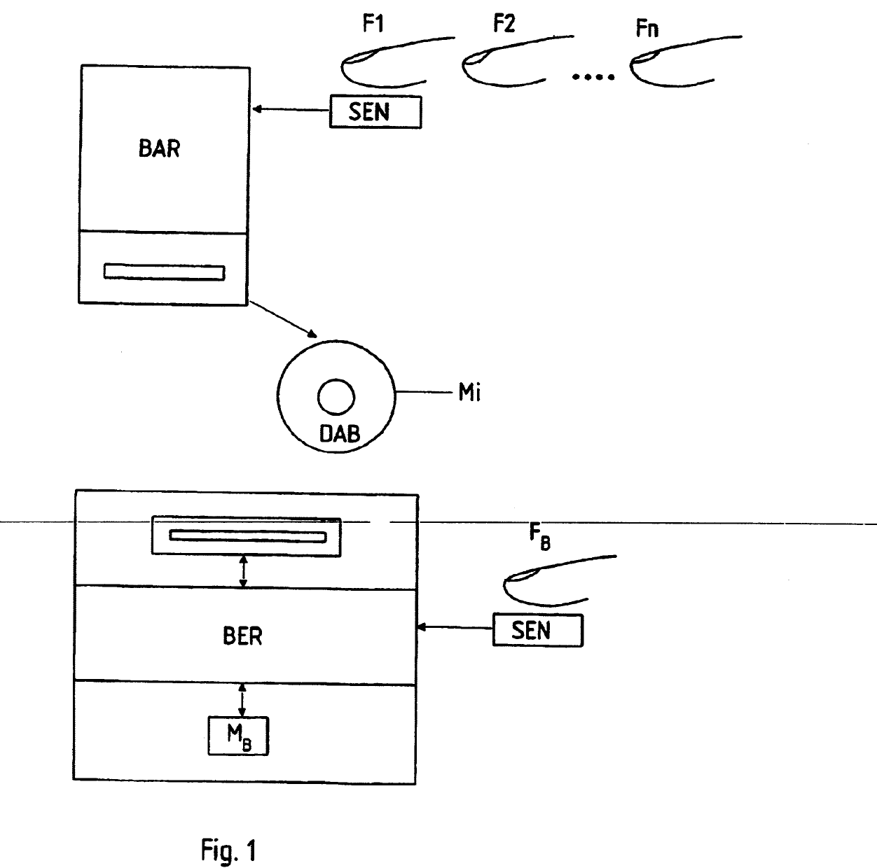

FIG. 1 shows a diagrammatical representation of the generation of a database as part of the method according to the invention and use of said database together with a biometric device,

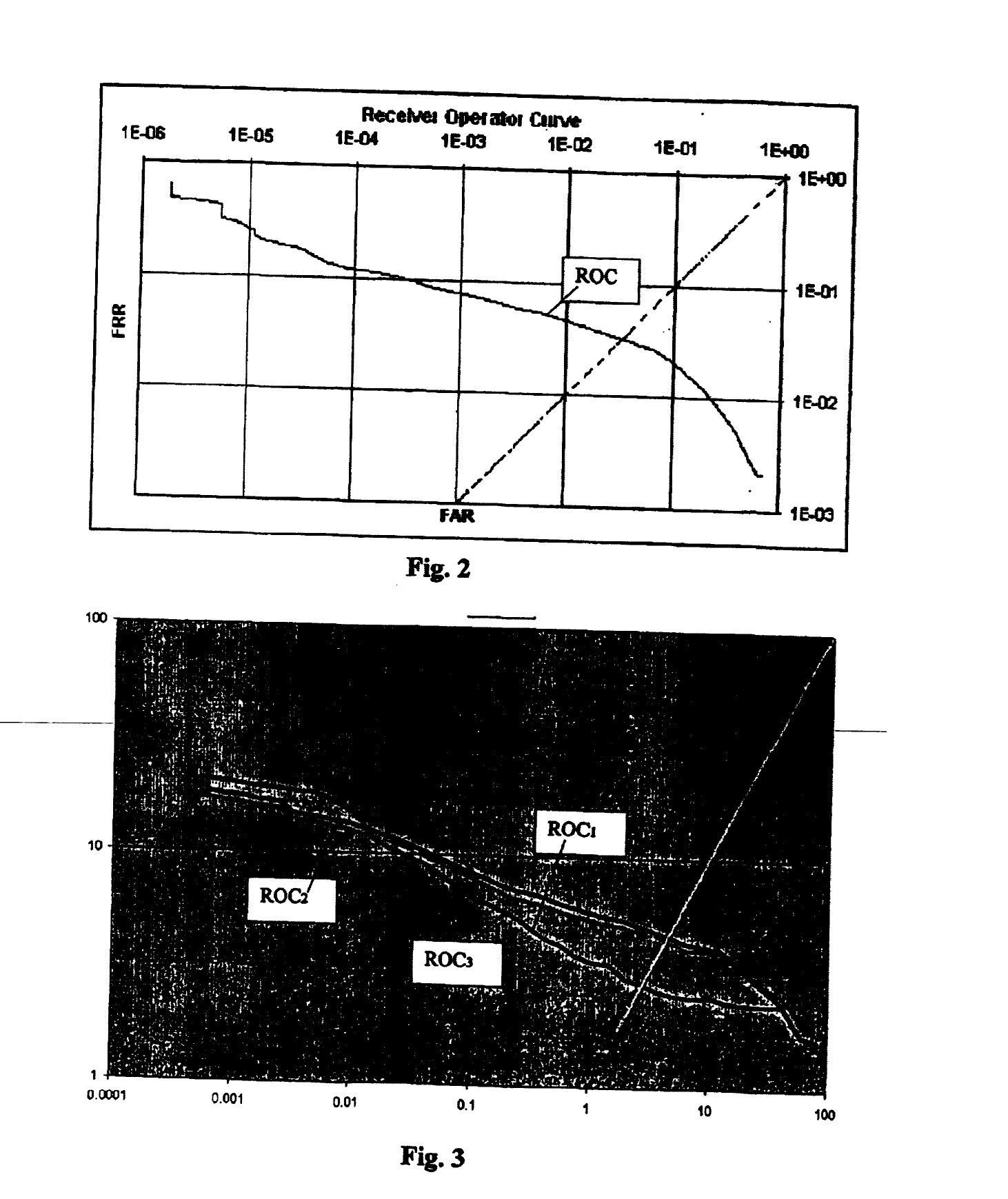

FIG. 2 shows a diagram of an example of the link between the false rejection rate and the false acceptance rate compared with an equal error rate, and

FIG. 3 shows a similar diagram, but on a different scale, of a representation like FIG. 2 but generated for three different users.

FIG. 1 shows that, with the aid of a device BAR which also has a biometric sensor SEN, biometric characteristics. in this case the prints of fingers F1, F2, . . . Fn, are scanned or recorded from a number n of persons and assigned to these persons. In a manner known to a person skilled in the art, the key characteristics are extracted in the device BAR from the information obtained behind the biometric sensor SEN and written as a characteristic set to a database DAB, which is for example implemented here as a compact disk.

The database DAB is then made available to a biometric device BER or delivered together with said biometric device to a user. When the device BER is installed, the user, here also designated as the authorized person, enters a personal biometric characteristic, e.g. of a finger FW by means of a sensor SEN. Again after extraction, a characteristic set of the current biometric characteristic M_{B} is generated, whereby it should be noted that this characteristic set M_{B} can also be generated by averaging repeated inputs of the biometric characteristic by the user. The characteristic set M_{B} is now filed in a memory of the device BER, and the user or authorized person can then initiate a testing process which serves to test out each of the characteristic sets Mᵢ of the database DAB against the personal characteristic M_{B} of the user.

In the course of the testing process, the personal error rates for the authorized person are determined, namely the false acceptance rate, which indicates the frequency with which access is granted by the device BER to an unauthorized person, and the false rejection rate FRR, which indicates the frequency with which the authorized person is rejected by the biometric device BER.

In particular, the false rejection rate FRR is determined in a series of tests not cited here in which the user has to ensure that no third party attempts access or entry. After for example several hundred trials, a false rejection rate FRR can be determined as a percentage, e.g. by counting the number of rejections or by analyzing the hit values that indicate how high rejection or acceptance was. If the characteristic sets are stored, then from these a curve of the false rejection rate FRR depending on a virtual threshold can be determined. In a similar manner, the false acceptance rate depending on a virtual threshold is determined by testing out the current personal characteristic M_{B} of the user against all foreign characteristics.

The curves determined in such a way for the false acceptance rate FAR and the false rejection rate FRR put the user in a position to determine his/her individual security himself/herself by adjusting the real threshold. The device can also display to the user a so-called “Receiver Operator Curve”, which is shown as an example in FIG. 2 and is labeled ROC. The straight line running at 45° in the diagram is designated the equal error rate and is drawn in for comparative and illustrative purposes.

FIG. 3 by contrast shows three different dependencies for various persons, FIG. 3 differing from FIG. 2 solely in the scale selected, which also has the result that the equal error rate has a different gradient here in FIG. 3. The curves inscribed in FIG. 3 for three different persons are labeled here ROC1, ROC2 and ROC3.

It is also possible to generate for the database DAB foreign characteristic sets with statistically distributed but virtual characteristics which behave in terms of their properties like characteristics of real persons. Such a database has the advantage that the possibility is excluded that a supplier to the foreign database will obtain false values for e.g. the false acceptance rate because his/her characteristic set is also located in this database.

It is actually only necessary to ensure that the artificially generated characteristic sets demonstrably behave like “normal” characteristic sets of real persons. This produces the advantage that the foreign characteristic sets do not have to be stored permanently but are generated temporarily as required, so that the storage space can be managed economically.

Particularly when using a database which contains datasets of existing persons, it is expedient to encode the database and to enable decoding only during the testing process run in order to protect the data of third parties.

The invention offers inter alia the advantage that in determining the error rates it can take individual persons into consideration, as a result of which appropriate security barriers can be determined with greater security and speed. This is illustrated for example by the analysis based on three test persons shown in FIG. 3.

1. A method for determining an error rate (FAR, FRR) for a biometric device (BER) which, when a biometric characteristic (M_{B}) of a person input by means of at least one biometric sensor (SEN) when prompted matches a characteristic (M_{B}) of an authorized person stored as a characteristic set, releases an access and, when said biometric characteristic does not match, rejects an access, whereby, in order to determine the error rate, a current biometric characteristic (M_{B}) of an authorized person is tested against a number (n) of foreign biometric characteristics (Mᵢ) and the error rates defined by the frequency with which access is granted for an unauthorized person and the frequency with which access for an authorized person is rejected,
characterized in that in the biometric device (BER) using a database (DAB) which contains a number (n) of foreign characteristic sets, a testing process is carried out to compare these foreign characteristic sets with the characteristic set of a stored current characteristic of the authorized person, and personal error rates (FAR, FRR) are determined for the authorized person on this basis.

2. A method according to claim 1,
characterized in that with the aid of a device (BAR) equivalent to the biometric device (BER) at least with regard to the scanning of biometric characteristics, biometric characteristics (Mᵢ) of various third parties are recorded and stored as foreign characteristic sets in the database (DAB).

3. A method according to claim 2,
characterized in that biometric characteristics are extracted from the information obtained behind a biometric sensor (SEN) and are stored in this form in the database (DAB).

4. A method according to one of claims 1 to 3,
characterized in that foreign characteristic sets with statistically distributed virtual characteristics are generated for the database (DAB) which in terms of their properties behave like characteristics of real persons.

5. A method according to one of claims 1 to 4,
characterized in that the current characteristic of the authorized user, stored as a characteristic set, is determined by averaging multiple scans of the current biometric characteristic of the user.

6. A method according to one of claims 1 to 5,
characterized in that the database (DAB) is encoded and is decoded only temporarily for the testing process.

7. A method according to one of claims 1 to 6,
characterized in that a false acceptance rate (FAR) and/or a false rejection rate (FRR) is determined as an error rate.

8. A biometric device (BER), having at least one biometric sensor (SEN), which is set to release an access when a biometric characteristic of a person input by means of the sensor when prompted matches a characteristic (MB) of an authorized person stored as a characteristic set and to reject an access when there is no match,
characterized in that the device (BER) is designed, by accessing a database (DAB) which contains a number (n) of foreign characteristic sets, to carry out a testing process for comparing these foreign characteristic sets with the characteristic set of a stored current characteristic of the authorized person and to determine on this basis a personal error rate (FAR, FRR) for the authorized person.

9. A biometric device according to claim 8,
characterized in that the database (DAB) contains foreign characteristic sets which are recorded with the aid of a device (BAR), equivalent to the biometric device (BER) at least in terms of the scanning of biometric characteristics, by recording biometric characteristics (Mᵢ) of various persons.

10. A biometric device according to claim 8 or 9,
characterized in that the database (DAB) contains foreign characteristic sets which are generated synthetically with statistically distributed virtual characteristics which behave in terms of their properties like characteristics of real persons.

11. A biometric device according to claim 9,
characterized in that characteristics which are extracted from information obtained behind a biometric sensor (SEN) are stored in the database (DAB).

12. A biometric device according to one of claims 8 to 11,
characterized in that the database (DAB) is encoded and the device is designed to enable decoding only during the testing process.

13. A biometric device according to one of claims 8 to 12,
characterized in that the determined error rate is a false acceptance rate (FAR) and/or a false rejection rate (FRR).
